(19) United States
(12) Patent Application Publication
(10) Pub. No.: US 2003/0033382 A1
(43) Pub. Date: Feb. 13, 2003

(54) Interactive communication system

(76) Inventors: Steven C. Bogolea, Pflugerville, TX (US); Douglas W. Monahan, Austin, TX (US); Delanor W. Nichols JR., Austin, TX (US); Thomas W. Bartling, Austin, TX (US)

Correspondence Address: William D. Wiese, Jenkens & Gilchrist, A Professional Corporation, Suite 3200, 1445 Ross Avenue, Dallas, TX, 75202, US

(21) Appl. No.: 10/265,221

(22) Filed: Oct. 4, 2002

Related U.S. Application Data
(63) Continuation of application No. 09/330,301, filed on Jun. 11, 1999.
(60) Provisional application No. 60/118,758, filed on Feb. 5, 1999.

(51) Int. Cl. G06F 15/16

(52) U.S. Cl. 709/218

(57) ABSTRACT

The present invention provides a method and apparatus for an operator to send Web pages to a customer, without the client having to enter the URLs of the pages to be sent. The operator can present an audio visual Web demonstration as he is speaking to the customer over the telephone. The operator can function as part of a call center that provides a central location for coordinates operators and incoming calls. By using a separate thread or process running on the client computer to control the browser, the flicker associate with redrawing the primary window, the security concerns associated with running a Java program, and the lack of control in using frames are all eliminated.

### RELATED APPLICATIONS

This application claims priority for U.S. Provisional Patent application No. 60/118,758, filed Feb. 5, 1999.

### TECHNICAL FIELD

The present invention relates to a system and a method for delivering information over a global computer network, and in particular, to delivering information over the World Wide Web (the“Web”) by directing a client's browser to specified resources.

### BACKGROUND OF THE INVENTION

Sales personnel send product information to customers to market goods and services. Service personnel also send product information to customers to assist in servicing the products. Traditionally, product or service information has been delivered by mail or facsimile to clients. Conventional mail is too slow to provide product information to customers when they are ready to make a purchasing decision or when they need information to service a product. Facsimile transmission provides information much quicker than does conventional mail. Facsimile transmissions are typically sent either by an automated fax-on-demand system or by a human operator in response to request for information.

There are, however, many disadvantages to using facsimile transmission to present sales and service information. Faxes require a phone connection, and a customer may need to interrupt a telephone conversation with a salesman to receive a fax, whereas when a centralized fax machine with a separate phone line is used, the customer may need to walk to the centralized fax machine to retrieve the facsimile. Artistic designs that are intended to encourage sales are less effective when transmitted because facsimile copies have relatively low resolution and are typically not in color. Moreover, fax machines can jam, facsimiles can be lost between the fax machine and the intended recipient, and the transmission of faxes can incur a long distance phone charge. If the client wants to receive information on many products, there can be a significant delay while the facsimile is being transmitted and printed. Moreover, customers may discover after reading a few sentences that the information is not what they needed, yet the resources to transmit the information have already been expended.

In addition, a fax machine is not always available to receive messages. It may be receiving another fax or transmitting a fax to another person. Thus, an operator who is trying to get information to a client must repeatedly try to send the fax until the transmission is successful. Despite the redial features available on most fax machines, multiple attempts to send a fax require some operator involvement and can result, therefore, in waste of operator's time.

Some prior art systems have attempted to solve the above problem by routing the fax message to a system for storing and delivering messages. For example, U.S. Pat. No. No. 5,675,507 discloses a message storage and delivery system to alleviate some of the above discussed problems, but the content limitation and the delay associated with receiving the message remain.

Due to the widespread accessibility of the Internet, another method of delivering information to clients is through the Web. The Web is comprised of servers on the Internet that utilize the HyperText Transport Protocol (“HTTP”). Clients who have a Web browser, such as Netscape Navigator or Internet Explorer, can access the information located on any Web server using the HTTP protocol.

The information located on the servers can represent text, graphics, audio, or video information. The information is rendered in the appropriate form by the browser or by an available auxiliary program, known as a plug-in. For example, a client may be able to play a digital movie on his computer delivered through the Internet as long as the client's computer has a movie player application.

Each information resource, such as a Web page or a file, that is accessible via the HTTP protocol has a unique address. The address of the resource, which is known as its Uniform Resource Locator (URL), is a text string identifying a specific file on a Web server, that is, a computer that monitors and responds to Internet communications on a particular port. Typically, the address of a file located on a server is of the form http://www.organization-name.organization-type/<pathname>/<filename>, such as http://www.uspto.gov/patents/introduction.html. Similarly, the address for a file located on a client's computer is of the form file:///<drive letter>|/<pathname>/<filename>, for example file:///C|/patents/introduction.html.

Thus, another way for a salesman to convey information to a customer is to telephone him, ask him to start the browser on his computer, and give him the URL of a file to access. If the operator wants the client to open another file, the client will be required to type the URL for the other file. Because of the long URLs, this process of communicating a URL to a customer and the customer subsequently typing the URL can take a substantial amount of time, resulting in delay and frustration. Moreover, the time required to download Web pages, particularly those having associated multimedia content, can be considerable. In addition, the client may be denied access to some files if those files are not publicly accessible on the Web. Consequently, the client can access only those files that are publicly available.

Further, to maintain a record of pages sent to the customer, the operator would have to record the URL of the requested file manually. The recorded information on URLs is useful for accounting purposes. Moreover, a statistical profiling of the information may provide useful marketing insight into the demand for information on products. Such information in a service environment may help product developers identify the most frequent problems associated with their product.

Rather than requiring a customer to type in a series of URLs, it is known that Web pages can be dynamically updated from a server by a server push function using Multipurpose Internet Mail Extension multipart messages. The browser updates the display as different parts of the multipart message arrive from the server. Such“server push” technology is not supported equally well by all browsers, and many browsers will ignore subsequently delivered parts of the document.

### SUMMARY OF THE INVENTION

Thus, it is an object of the invention to provide a system and method for delivering information using a communication network, such as the Internet.

It is another object of the invention to deliver such information by controlling a Web browser and having it download pages specified by an operator.

It is a further object of the invention to eliminate the delay incurred in communicating addresses of the information, such as URLs of files to a client and the subsequent delay associated with typing the URL.

It is yet another object of the invention to deliver multimedia information content that is not publicly accessible over the Web.

It is still another object of the invention to automatically record the URLs of the files delivered to various clients for accounting and profiling purposes.

It is still a further object of the invention to keep track of operator activity and route new information requests to the operator having the lightest work load.

It is still another object of the invention to display to a customer multimedia information located on his computer.

The present invention allows an operator using information transfer software on one computer to control the information displayed by a network interface program, such as an Internet browser, on one or more other computers. The operator may be, for example, a salesman providing product information to a potential customer or a service representative providing a customer with information to solve a problem. For example, a salesman operator discussing products over the telephone would be able to have the customer's browser display a Web page or series of pages of product information, without requiring the customer to manually type in a series of URLs. Upon determining customer's information needs, an operator can direct the customer's browser to retrieve one or more HyperText Markup Language (“HTML”) files from a Web server. The HTML file may contain references to text, graphics, audio or video files. The Web browser located on the customer's computer system displays the file to the client, using helper applications, such as Adobe Acrobat, as necessary.

The customer's browser can be directed to display information from any source, such as the Internet, the operator's local computer or local area network, or from storage medium at the customer's computer. For example, upon purchasing a product, the manufacturer may have provided the customer with a compact disk (“CD”) or digital video disk (“DVD”) that contains a multimedia presentation of service information. While later discussing a service problem, a service operator can direct the customer's browser to display information from the previously supplied CD or DVD contains multimedia service information, thereby avoiding the lengthy download time typically required for multimedia presentations.

The operator may employ a stand-alone computer, such as an Apple McIntosh computer or an IBM compatible personal computer, running a Windows-based operating system, such as Window's 98 or Windows NT. Alternatively, a group of operators may work together and be coordinated through a call center. The operator can be in contact with the customer over the telephone or through Internet Relay Chat while sending pages to the customer's browser over the Internet. Alternatively, the operator can send a presentation to the browser, using a prerecorded or automatically generated telephone presentation to accompany the browser presentation, or without supplementing the information over the telephone.

The customer's browser is controlled by opening a second window, a child control window, on the browser. Using a child control window to control refreshing of the primary browser window avoids unnecessary redrawing of the primary browser window, thereby eliminating unnecessary download delays and flickering. The second window is a second thread or process running within the same process or operating system as the main browser window. Using a second thread or process, preferably within the browser process, avoids the security risk inherent in, for example, running a Java application on the customer computer to control the browser. Moreover, by using a thread or process running within the browser process, much of the overhead involved in switching between independent processes is avoided. Using a separate window also makes the application more robust than, for example, using frames. A frame could be closed and the session terminated without an intention to do so by the operator or the customer, by an instruction in an HTML page downloaded from a third party.

The child control window refreshes itself from a URL on the operator's computer or on a server at a call center. If the information to be displayed in the customer's main browser is to be changed, the refresh page will include a instructions, such as JavaScript script code, that sends the main browser window to a new URL.

In some embodiments, multiple operators work together, coordinated by a call center. The call center functions as a single server for all the operators, thereby allowing tracking of all customer contacts and the compilation of statistics for all operators and customers. For example, the call center can maintain a record of the number of customers contacted and the Web pages sent to the customers. Such information can be correlated with sales information to determine the effectiveness of the sales presentations and operator performance.

A connection between an operator and a customer can be established in several ways. The operator may telephone the customer and provide him a URL to type into his browser. The URL would be for a server, either on the operator's computer or at a call center, that will initiate an information transfer session.

Alternatively, a customer may locate the server while “surfing” the Web, and chose an option that provides a presentation of a series of Web pages back to the customer. The server may also provide an option of establishing a telephone connection with the operator or of being called with a prerecorded or generated voice to supplement the presentation as it is being displayed by the browser.

When the customer selects an option presented by the server, a form can be presented to the customer by his browser requesting information about the user, such as the user's name and telephone number. When the customer form is completed and submitted, the server takes appropriate action depending on the option that was selected. For example, the call center may establish both an Internet information transfer session and a telephone connection between the customer and the operator. The operator can then determine what information to send to the customer and can discuss the information with the customer as it is displayed. The server could also be used to launch an automated presentation shown in the customer's browser. The automated presentation could be coordinated with separate CTI (computer-telephony integration) server through a TCP/IP link to deliver voice with presentation.

The present invention directs the customer's browser to load information from anywhere on the Internet or the local computer. By directing the browser to load, rather than sending the information as in a multi-part mail message, the customer's computer is able to receive information at its own rate, and the customer is free to navigate the browser outside of the session content without the operator losing the option to redirect the browser.

The present invention provides a new, highly efficient system and method for delivering multimedia information to clients using conventional telephone network and Internet. The invention is particularly useful in delivering marketing information to clients and service information to clients.

Additional objects, advantages and novel features of the invention will become apparent from the detailed description and drawings of the invention.

### BRIEF DESCRIPTION OF THE DRAWINGS

FIG. 1 is a schematic diagram showing an operator and a customer and the connections between them.

FIG. 2 is a block diagram showing the parts of the information transfer software running on an operator computer of FIG. 1.

FIG. 3 shows the events that occur in a typical session between the operator and customer of FIG. 1.

FIG. 4 is an example of a log-in page sent from an operator of FIG. 1 to a customer of FIG. 1.

FIG. 5 shows a child control window used to control the pages displayed on the primary browser window.

FIG. 6 shows the steps involved in the operator of FIG. 1 sending information to the customer of FIG. 1.

FIG. 7 shows a typical computer screen of an operator of FIG. 1 and the corresponding screen sent to the screen of a customer of FIG. 1.

FIG. 8 shows a preferred interface for use by an operator of FIG. 1.

FIG. 9 is a schematic diagram showing multiple operators working together and coordinated by a call center.

FIG. 10 shows the steps involved in establishing contact with an operator in a call center.

FIG. 11 shows the steps involved when a call center is contacted by a customer over the Internet.

FIG. 12 shows an operator using the invention from behind a firewall.

FIG. 13 shows the steps involved in establishing a data transfer session for an operator operating behind a firewall and using a proxy.

FIG. 14 shows a screen presented to an operator to select an agent to open a customer's browser.

FIG. 15 shows a window of an agent running on a customer's computer.

### DETAILED DESCRIPTION OF PREFERRED EMBODIMENTS

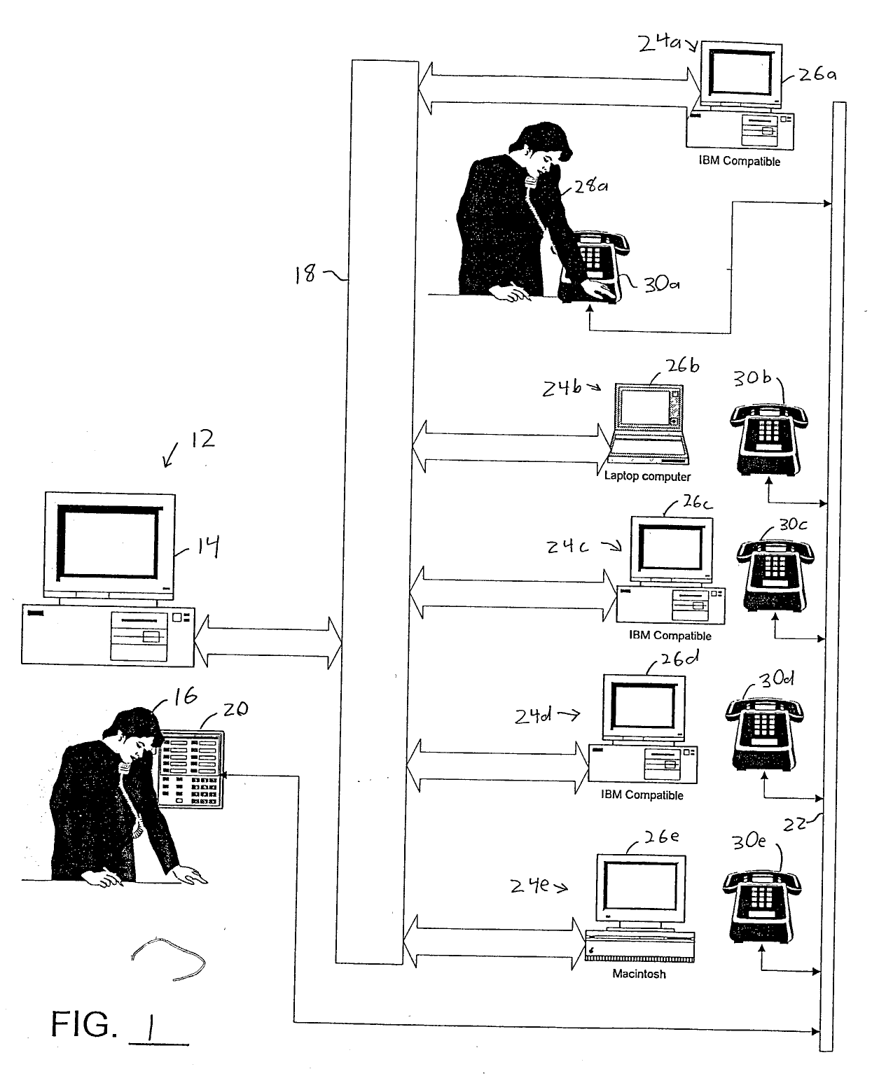

FIG. 1 shows an operator station 12 comprising an operator computer 14, controlled by an operator 16 and connected to a computer network 18, such as the Internet, and an operator telephone 20 connected to a telephone network 22. Likewise, customer workstations 24a, 24b, 24c, 24d, and 24e each includes a customer computer 26a, 26b, 26c, 26d, or 26e operated by a customer 28a, 28b, 28c, 28d, or 28e (only 28a shown) connected to computer network 18 and customer telephones 30a, 30b, 30c, 30d, and 30e connected to telephone network 22. Operator 16 at computer 14 can send and receive data to any of customer computers 26a-26f over the Internet 18 and can speak to any of customers 28a-28f over the telephone network 22. A typical one of customer workstations 24a-24f, customer computers 26a-26f, customers 28a-28f, or customer telephones 30a-30f is referred to below as customer workstations 24, customer computers 26, customers 28, or customer telephones 30, without the letters“a” through“f”.

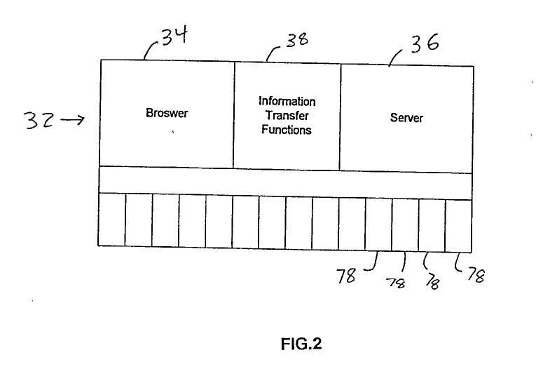

Operator computer 14 is running information transfer software 32, shown schematically in FIG. 2. Information transfer software 32 includes browser software 34 similar to that in an Internet Web browser program, such as Netscape Navigator or Microsoft Internet Explorer, but also includes an HTTP daemon server software 36 that allows computer 14 to function as a server, rather than merely as a client. The server software 36 provides the minimum functionality required to monitor TCP/IP communications on a port and to respond to simple requests for pages from the client computer. Such server software is well known in the art and is available, for example, from Apache Digital Corporation, Durango, Colo. The server also uses programs, such as those written using the common gateway interface (CGI), to deliver information located on the server or information located on any other server that the operator 16 can access through the Web.

The server program 36 allows multiple clients, for example, fifteen clients in one embodiment, to simultaneously log into information transfer sessions controlled by operator 16. Information transfer software 32 also includes functional software 38 that allows operator 16 to specify pages to be displayed by a browser program running on customer computer 26, as described below.

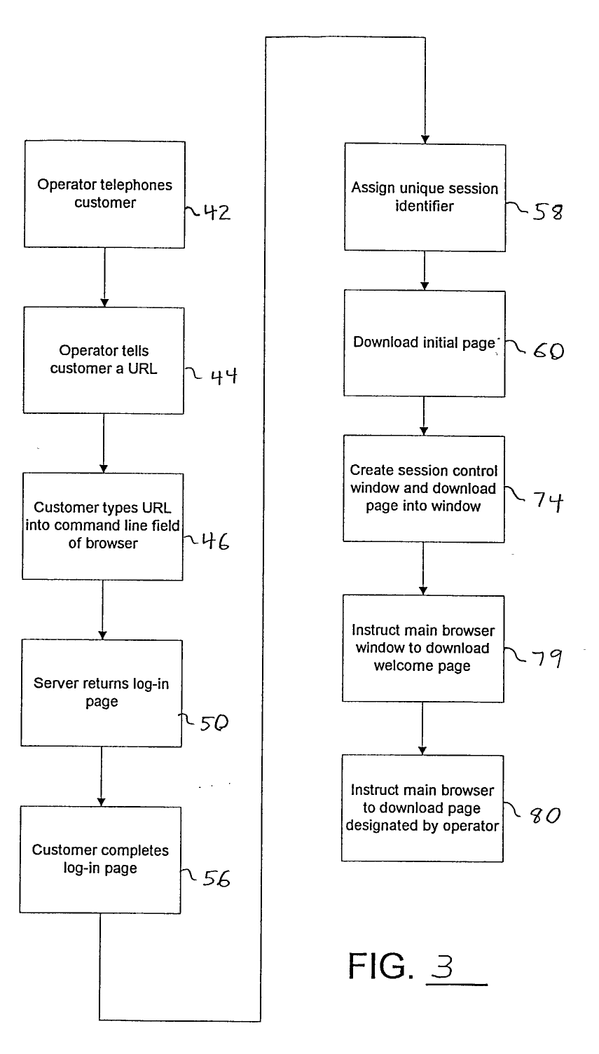

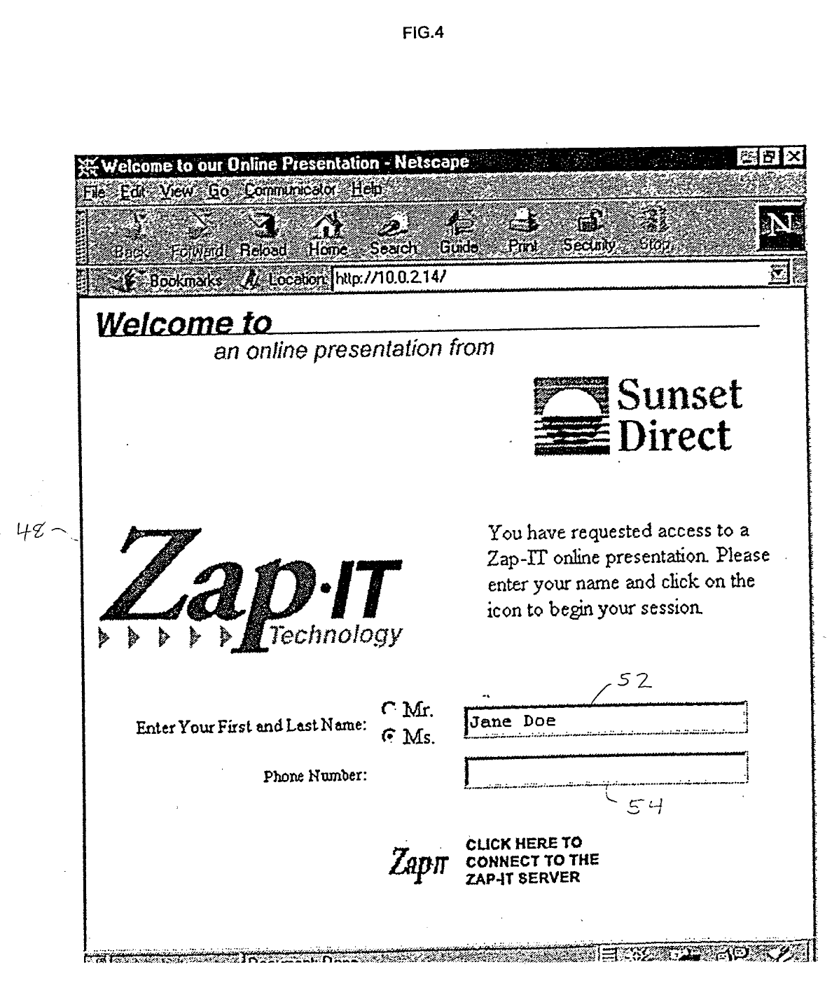

FIG. 3 shows the events that occur in a typical information transfer session in accordance with the present invention. Step 42 shows that a typical interaction begins when operator 16 telephones customer 28. The operator may know the customer's phone number from a previous contact, a customer list, or a sales lead. Step 44 shows that operator 16 tells customer 28 a URL over the telephone. Step 46 shows that customer 28 types the URL into the command line field of the browser display window to instruct the browser to contact the server and request the file identified by the URL. The URL corresponds to a log-in page 48 (FIG. 4).

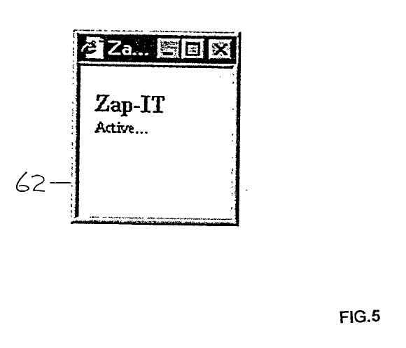

Step 50 shows that server software 36 on operator computer 14 responds to the contact by client computer 26 by transmitting a log-in page 48 to client computer 26. FIG. 4 shows that log-in page 48 includes a name field 52 and a telephone number field 54 for the customer to enter information including, for example, his or her name and telephone number. Log in page 48 can also include fields to enter any other information that the system designer feels appropriate to the particular application. Step 56 shows that the customer completes the log-in page and transmits it to computer 14. Upon receipt of completed log-in page 48, step 58 shows that information transfer software 32 assigns a unique session identifier to the session and transmits in step 60 an initial page to customer 28. The initial page includes instructions, such as a JavaScript program, to create in step 74 a child window, referred to as a session control window 62 (FIG. 5), and provides session control window 62 a URL of an HTML page to open in session control window 62.

In step 74, the client browser window runs the JavaScript program and creates control window 62 and downloads the page from the server. Control window 62 appears as a small window displayed on the customer's screen, and is opened“in focus,” that is, as the active window that processes input. Control window 62 displays the information transfer session status: either“pushing” when new information is being downloaded into the main browser window, or “waiting” when no information is being downloaded. In step 76, control window 62, running a JavaScript command from the page downloaded from the operator computer 14, instructs the main browser window to download a welcome page.

The information transfer session between operator 16 and customer 28 is now established. Control window 62 instructs the primary browser window to download a welcome page in step 79. The welcome page is an HTML page indicating to customer 28 that he has logged onto an information transfer session. The welcome page typically includes a welcoming message explaining the information transfer process, as well as product information attractively portrayed. The welcome page also includes a log-off icon for the customer to click on to log off of the information transfer session. The log-off icon sends the browser to a log-off URL on operator computer 14 that informs operator 16 that the information transfer session has been terminated and closes session control window 62. After the welcome page is displayed for a time in the primary window, control window 62 instructs the primary browser window to download a page indicated by operator 16 in step 80.

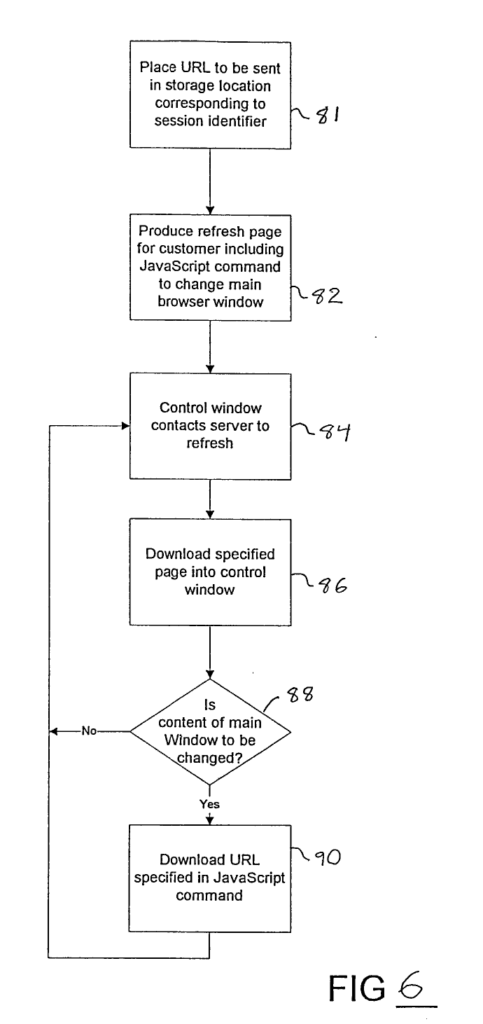

Operator computer 14 maintains a storage location 78 (FIG. 2), either in a file or in random access memory, for each connected customer computer 26. The storage location 78 contains the URL of the page to which operator 16 is directing the customer's browser. FIG. 6 shows the steps involved in sending new content to customer computer 26. Step 81 shows that information transfer software 32 places the URL in the storage location 78 in response to actions by the operator 16 indicating the page to be sent.

Step 82 indicates that the server dynamically produces a refresh page for the control window. The refresh page will include the following items:

1. A JavaScript program to direct the main browser window to a new URL, using the OpenLocation command, if the URL has changed. If there is no new content to view, the Java Script code is not included in the refresh page, thereby reducing the amount of Java Script executions in the client's browser.

2. A value for the REFRESH meta-tag, including the specific URL for the control window in the browser to request; and

3. The condition of the information transfer session, either waiting, if the page contains no java-script program, or pushing if the page contained an updated link for the main browser window.

The page also includes one meta-tag with an expiration date and another with a “no-cache” instruction to prevent caching of the page, which would prevent a customer from knowing when the page has been updated.

Step 84 shows that the control window 62 contacts operator computer 14 because the refresh meta-tag of the current page indicates that it is time for the page to be refreshed. Step 86 shows that the client browser downloads the page prepared in step 82. Step 88 shows that, if the content of the memory location in the operator computer 14 has changed, the JavaScript program causes the customer's main browser window to contact and download the new page in Step 90. After the new page is downloaded, the refresh cycle continues with step 84. If the content of memory location 78 in the operator computer 14 has not changed, no instructions are issued to the main browser window and the refresh cycle is continued with step 84.

This process is repeated as the control window refreshes itself periodically until the control window is closed or the operator sends a log-off page. The server dynamically produces refresh pages for each refresh request, typically every 5 seconds. Changing the refresh metatag value changes the refresh period, and the operator software preferably allows the operator to enter a new preferred refresh period. A single operator can be controlling browsers of multiple clients, allowing one operator to present a display to multiple individuals.

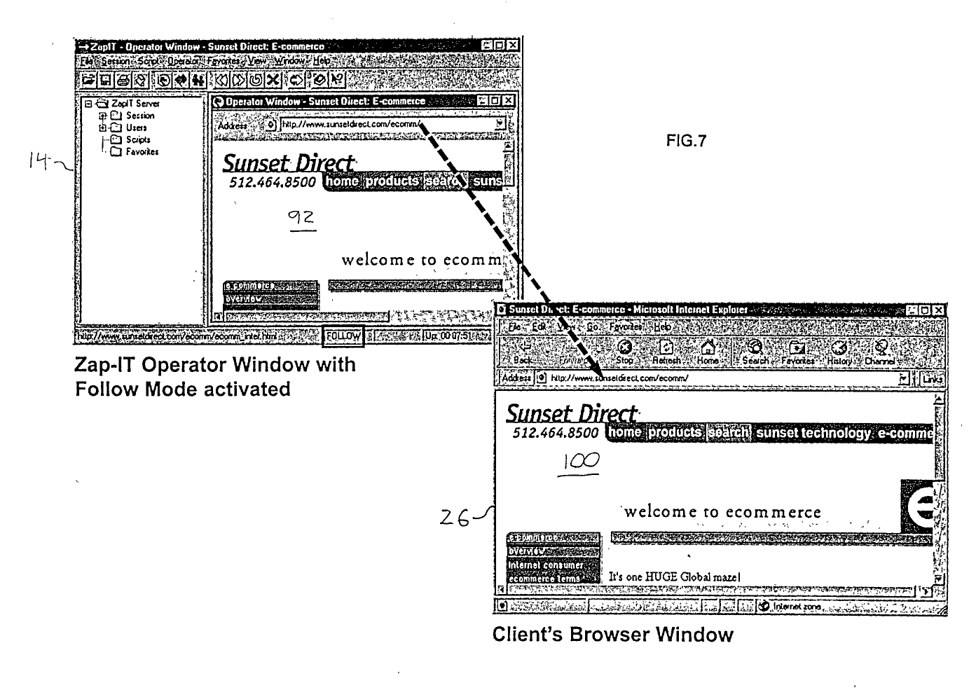

Preferred operator software 32 is a Windows-based system that provides the several modes of operation available. In “follow” mode, the operator has a window on his screen that appears like a typical browser. FIG. 7 shows the relationship in follow mode between an image 92 on the screen of operator computer 14 and an image 100 on the screen of customer computer 26. When the operator navigates his browser to different sites, the customer's browser is automatically directed to the same sites. Alternatively, in manual mode, operator 16 can enter a specific URL, and the customer's browser will be sent to that URL. In another mode, the operator can run a presentation script, which leads the customer's browser through a presentation of information. Frames, that is, multiple URLs displayed on a single page, are preferably sent in manual mode or using a presentation script, by sending the primary page to the customer, and letting the primary page call it frames in the normal manner. In follow mode, frames may not display properly on the customer's computer because as each frame is loaded into the operator computer, it is separately sent to the customer's computer to be loaded as a separate URL. Frames can be sent properly Several clients can be connected to a single operator, and the operator can navigate the customers together or separately. Skilled persons will be able to program these modes and others based on the description above.

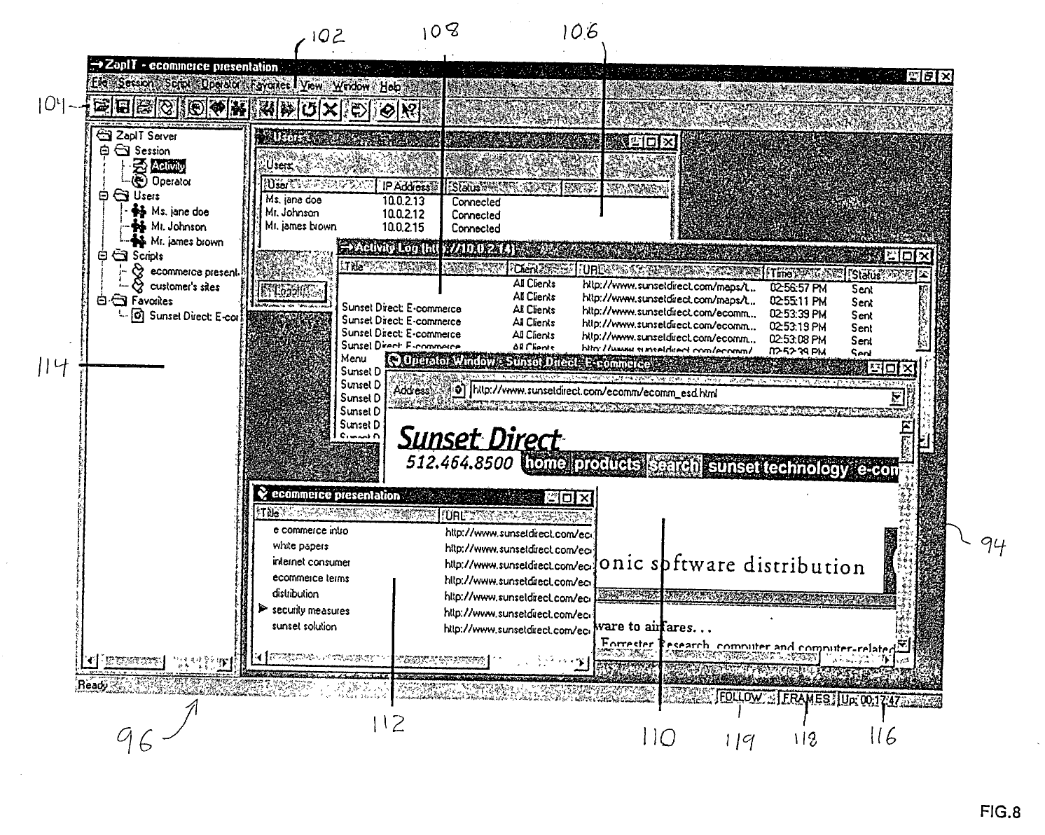

FIG. 8 shows a computer screen 94 showing a preferred operator interface 96. The operator interface 96 provides operator 16 several windows to facilitate controlling the content displayed on customer computer 31. The operator interface 96 includes a menu bar 102, and a toolbar 104 for accessing commands. The interface 96 includes a user's window 106 that lists customers 28 that are currently logged onto the information transfer session. An activity window 108 present a chronological list of all pages that have been sent to customers 28 during the session, along with the time each page was sent, whether each customer computer 26 received the instruction to load the page, and optionally, the HTML title tag for the page.

An operator window 110 shows to operator 16 the content of pages sent to the customer 28. Operator window 110 is used to navigate through Web pages, like a browser. When follow mode is enabled, the pages viewed by operator 16 are also sent to any customers 28 that are logged into the current information transfer session. A script window 112 can be opened and used to edit scripts comprising lists of Web pages to which the customer is to be directed. Lastly, a shortcut window 114 lists in hierarchical fashion all the windows that are available to the operator, allowing operator 16 to rapidly locate and view any information he needs. The interface also includes a session timer 116 that shows the operator how long the session has been active, and a frames indicator 118, showing that the page being sent to the customer uses frames.

The operator can provide customers with a CD, DVD, or other removable media to avoid the time required to download multimedia content. For example, a CD may include large volumes of information such as technical data, sales information, or instructional material. Because different customer computers 26 may have different letter designations for different drives, it is necessary for the operator 16 to determine the letter designation of the drive having the removable media so that the operator 16 can determine a URL for the file when instructing customer computer 26 to load the file. One way of determining the drive on which the media is located is to include a key file on the media and then search the client's entire computer system to locate the key file. The drive on which the key file is located is then known to be the drive on which the other files are located. A key file could be, for example, a file containing only one byte of data and having a distinct file name. A JavaScript program included in a refresh page of the control window 62 can instruct customer computer 26 to search for the key file, thereby identifying the drive to be accessed. The content of the removable media could be copied onto another media and the key file would still be located.

Operator 16 can also provide information that is on his local drive or a network drive. To present such information, a copy of the information is placed in a temporary file in a directory accessible to the server. The file can then be identified by a URL and the server can send it to customers 28 upon request. All files that are accessible by the customer through the Internet are maintained in a separate directory and only files in that directory are accessible to customers 28, thereby preventing other files on the system from being inadvertently sent to customer 28. To minimize the file storage space required and to prevent files from being generally accessible to the public over the Internet, files copied onto the customer-accessible directory are deleted after being downloaded by customer 28.

The Web pages to which customer 28 is directed can be a programmed presentation sequence or individual pages that the operator 16 decides to send to the customer 28, based upon the telephone conversation between the operator 16 and the customer 28. Communications between the operator 16 and the customer 28 could also be performed over a chat function, instead of a telephone connection.

Described above is the basic method and apparatus for controlling the information displayed on an Internet browser on another's computer. The embodiment described above was implemented on a stand-alone operator computer 14, although multiple operators can work together using common software.

Call Center

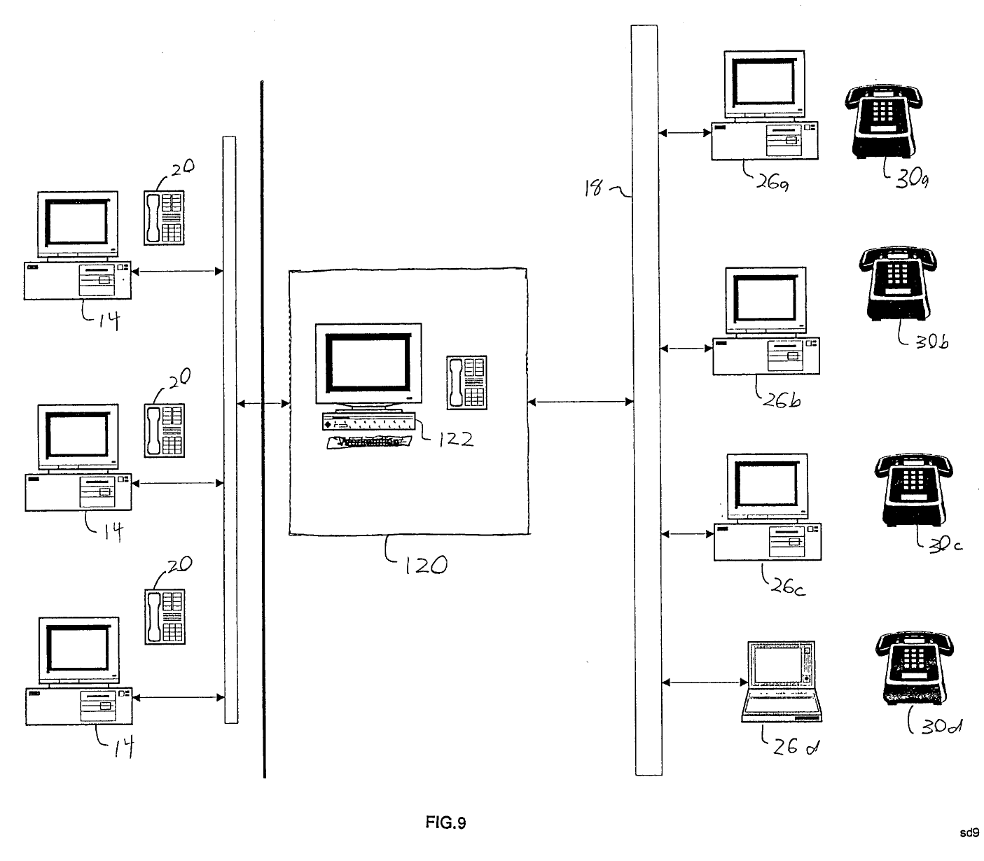

In another embodiment, shown in FIG. 9, a group of operators work together, coordinated by a call center 120. Call center 120 includes a call center Web server 122 that services requests from customer computers 26 and allows operators 16 at operator computers 14 to direct customer browsers to specified URLs when customer computers 26 refresh from call center Web server 122. Call center 120 is implemented using a collection of programs using, for example, the CGI protocol.

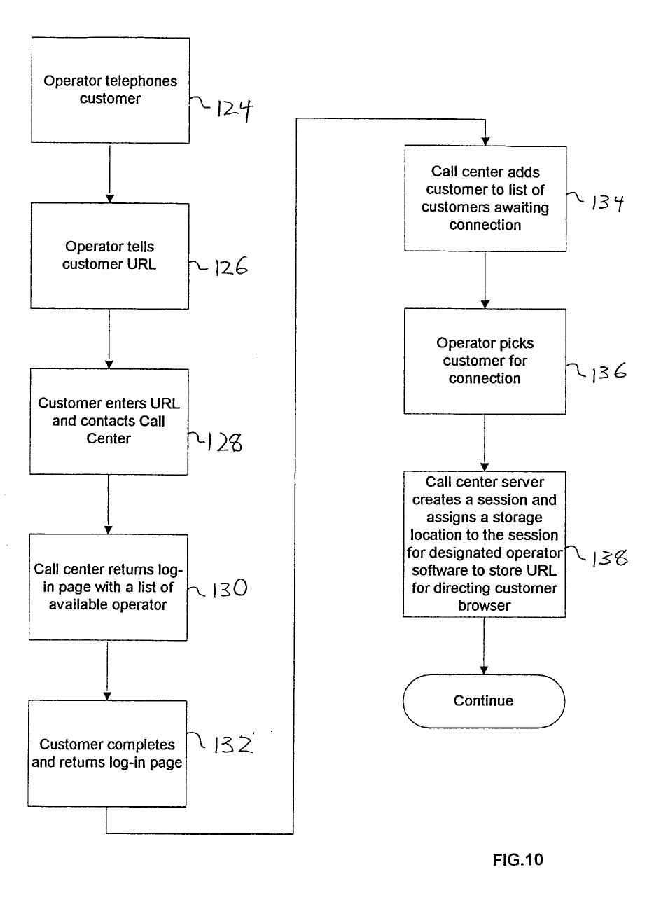

FIG. 10 shows the typical steps involved in operating within a call center 120. As with a stand-alone operator, step 124 shows that the contact may begin when operator 16 telephones a customer 28, and in step 126 operator 16 tells customer 28 a URL to enter into the command line of his browser. The URL provided is hosted on the call center server 122, rather than, on the individual operator computer 14. In step 128, customer 28 enters the URL into the command line of his browser, which contacts call center server 122. In step 130, call center server 122 returns to customer 28 a page of available operators 16 from which customer 28 can choose, including an option for choosing “any available operator.” Customer 28 completes a log-in page in step 132. In step 134, call center server 122 adds customer 28 to a list of waiting and available customers 28 provided to each operator. If a customer 28 specified an operator, that customer appears only on the list of the specified operator. In step 136, operator selects customer 28 and in step 138, call center 120 creates an information transfer session and assigns the session a storage location, which is accessed by operators information transfer software 32. The information transfer session then continues as described above with respect to the stand-alone operator.

The information transfer software running on the operator computer 14 functions in a manner similar to that of information transfer software 32 used in stand-alone mode, that is, by an individual operator, but it does not include the server functionality. The storage location that specifies the URL to which the customer's browser is to be directed is located on the call center server 122, rather than at operator computer 14. By having all communications go through call center 120, security is enhanced and the sponsoring company is able to track and maintain statistics on system usage, such as, which Web pages are being sent to customers 28 at what frequency and the efficiency of operators.

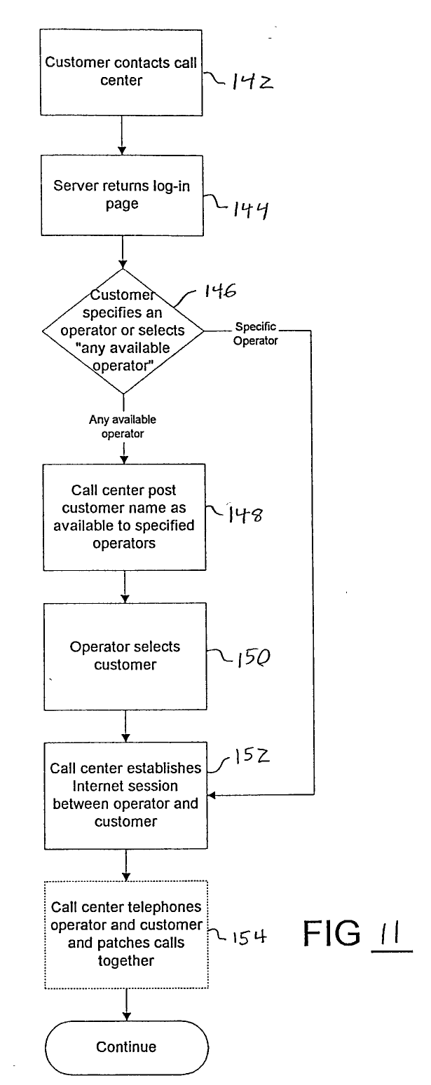

A customer may contact call center 120 through the Internet, without being first contacted by an operator. FIG. 11 shows how call center 120 can match up a customer 28 with an operator 16. For example, customer 28 may locate call center 120 by surfing the Internet and initiate contact with call center 120 in step 142. In step 144, call center server 122 returns a log-in form page, requesting contact information. The form page lists the available operators 16 and asks customer 28 whether he wishes to be connected with a specific operator 16 or any available operator 16. First time callers will likely chose any available operator 16, whereas customers 28 that have worked with a specific operator 16 in the past may chose to continue working with that operator 16. Customer 28 selects an operator or“any available operator” in step 146.

If customer 28 selected“any available operator” in step 146, call center server 122 in step 148 post customer 28 to a list provided on the screen of each operator 16 of customers 28 that are waiting and available for connection. When an operator 16 selects a customer 28 in step 150, call center server 122 removes that customer 28 from the list of available customers 28 and establishes in step 152 an Internet connection as described above. If customer 28 had specified a particular operator 16 in step 148, that customer 28 would be connected to the specified operator 16 in step 152. In step 154, call center server 122 optionally commands an external server to initiate a telephone call to customer 28 and to operator 16, and connects the two lines to establish a telephone connection between customer 28 and to operator 16. The telephone connections can be preformed by a separate telephone server computer, working in coordination with call center server 122.

After a connection is established between call center 122 and customer 128, a login page is returned to the customer 28. The log-in page includes fields requesting the customer's name, phone number and other information useful to operator 16. Upon receiving the posted information, the call center server 122 establishes a Web connection between the operator 16 and the customer 28 by assigning a session identifier and assigning a storage location to hold the URL to which the customer browser is to be directed. If a telephone message was also requested, call center server 122 commands an external server to telephone the customer 28. Call center server 122 may then automatically navigate customer 28 to various Web pages while an explanation is provided over the telephone by a recorded or automatically generated message. Customer 28 may also be given an option of speaking with an operator at various times in the automatic presentation.

The same operator software can preferably be used both in stand-alone mode or with a call center 120, with a switch that operator 16 can use to specify which mode is being used. The software allows an operator 16 to specify the port number that the software will use for a session and the default location of local content. Operator 16 can also set the refresh rate and the amount of time after downloading a document until it starts the refresh cycle.

Various implementations of a call center may perform less than all the functions described above or may add additional functions without departing from the invention. For example, the call center may only connect customers 28 with prerecorded messages that are coordinated with a series of pages automatically sent to the customer's browser. A CGI program in the call center keeps track of the URLs accessed for accounting and record keeping.

Firewalls

Most private networks that are connected to the Internet operate behind a firewall, which protects their private network from attacks over the Internet that would steal or corrupt data or disrupt communications on the network. A firewall typically consists of a system or group of systems that determine what traffic is permitted between a local network and the Internet. One such system checks the content of TCP/IP packets and allows only those coming from a known safe address to enter the network. A system, an application level system, typically includes a proxy that takes the place of a server behind the firewall in communication with the Internet. Contacts are made from the Internet to the proxy, which then contacts the server. Firewalls typically do not permit unsolicited communications from outside the network, with a few exceptions, such as e-mail.

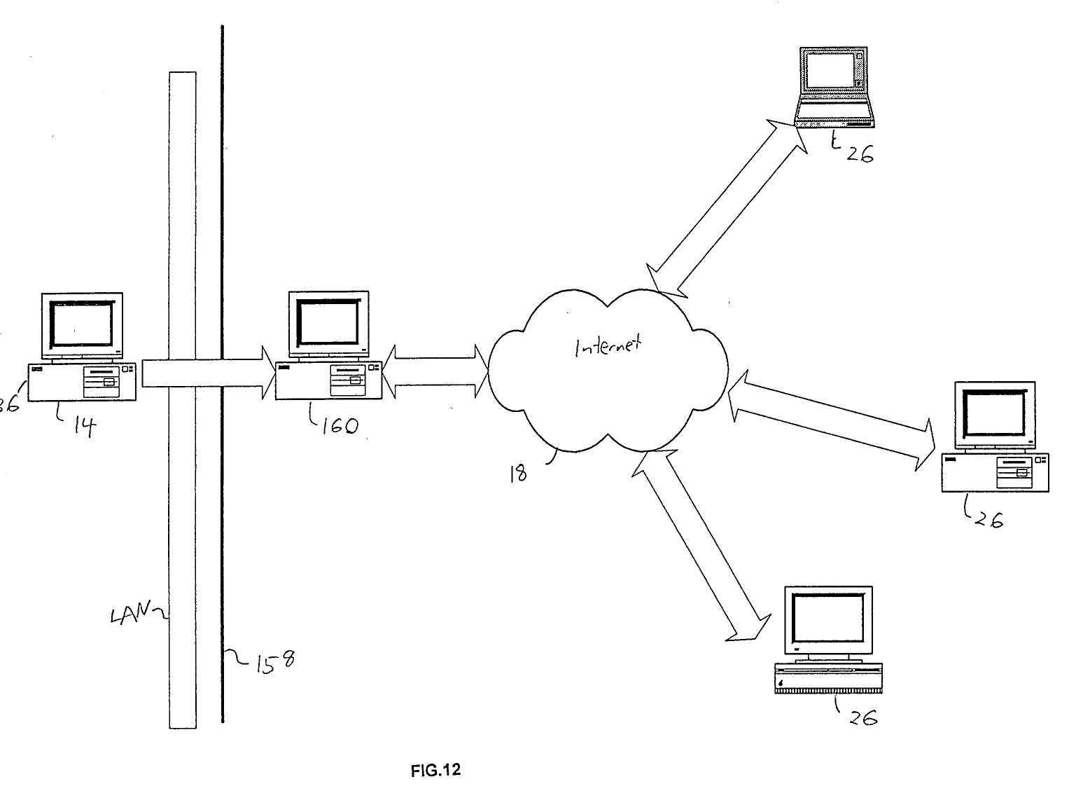

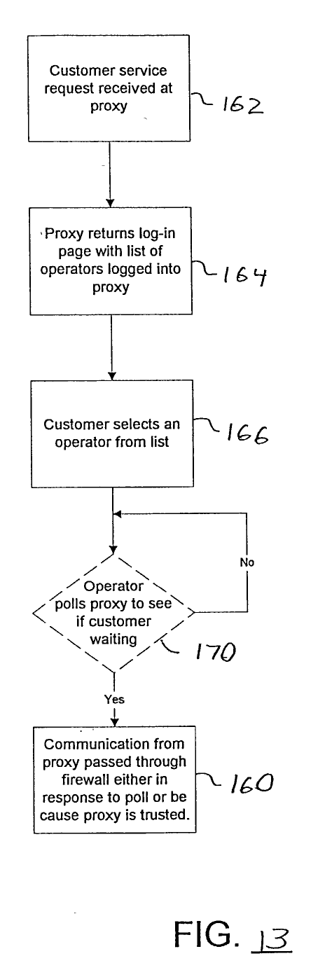

FIG. 12 shows an operator computer 14 operating behind a firewall 158. Firewall 158 would normally stop communications to the operator's Web server 36 from the customer computer 26, because the communication would not be in response to a communication from operator 16. One solution is for the operator 16 to use a proxy 160 outside of the firewall 158. FIG. 13 shows the steps for a customer 28 to contact an operator 16 operating behind a firewall 158 and using a proxy 160. Step 162 shows that the customer 28 requests service, using the URL of the proxy 160, which may be provided by the operator 16 over the telephone. Step 164 shows that the proxy 160 returns an HTML page to the customer 28 with a list of operators 16 that are logged into the proxy 160. In step 166, customer 28 selects an operator 16, and proxy 160, when it receives communications from the customer 28 then forwards the communication to the operator 16 in step 168. Because proxy 160 is outside of the firewall, it typically cannot initiate contact on port 80, the normal Web server port, with the operator 16 inside firewall 158. Firewall 158 may be programmed, however, to pass communications that originate from proxy 160, although this poses the danger of others sending packets falsely indicating that they originate from the proxy 160. As with known application level firewall systems, proxy 160 is programmed to pass on only legitimate requests to the server 36 behind the firewall. Alternatively, step 170 shows that operator computer 14 can optionally poll proxy 160 regularly to determine whether a customer 28 is waiting to connect. Firewall 158 will pass communication from proxy 160 if the communication is in response to a poll from operator computer 14 inside firewall 158.

Although in some respects proxy 160 functions like call center 120, call center 120 performs the server functions outside of the firewall, whereas the proxy, although appearing to the customer 28 as the server, merely passes the requests to the operator computer 14 inside firewall 158, and does not store, for example, the location of the URL to be passed to the customer browser. A single proxy can serve multiple operators 16, or multiple proxies can be used, with each having access only to its registered operators 16. There can be multiple proxies servicing operators 16 behind a firewall.

Call center server 122 operates outside of the firewall, and can be contacted directly by customers 28. As with proxy 160, the call center would be unable, however, to contact the operators 16 within the firewall. One solution is to have the operators 16 periodically poll the call center to update the customer waiting list. Polling, however, creates unnecessary traffic over the network. It would also be possible to allow unsolicited communications from call center 120 to pass through the firewall to each of the operator computers 14. The call center server 122 can act as a “bastion host,” that is, an application level firewall element that securely controls communication between the Internet and the inside operator computers 14.

Software Agents

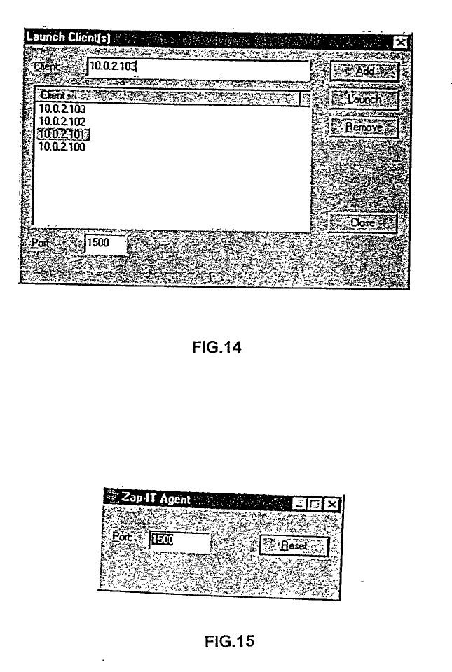

In the embodiments explained above, the information transfer session was initiated by the customer 28 by starting his browser and instructing it, by manually entering a URL or by activating a link, to contact an operator 16 or call center 120. In another embodiment, the session can be initiated by the operator 16. In order for the customer 28 to know when the operator 16 wishes to send Web pages, customer computer 26 runs an “agent,” that is, a software program that checks for communications from the operator 16. The agent can be set to automatically run whenever customer 28 starts his computer. FIG. 14 shows a screen provided by operator software 32, allowing operator 16 to select an agent to open a customer browser. FIG. 15 shows an agent window running on customer computer 26 and allowing customer 28 to set the port which the agent monitors. The agent runs in the background, listening on a port, preferably other than port 80, for a command that instructs it to load the browser and direct it to a specified URL. A default port of 1,500 is used to avoid interference with other Internet protocols.

When the agent detects a command indicating that the operator 16 has information to send to the client, the agent starts the client's browser, and has the browser request the information. The requested page then opens a child control window 62 as described above, and the process continues as described above. If a customer 28 is behind a firewall, the firewall will block the incoming request to the agent, and the agent will not know when information is available. A customer proxy can be used to communicate to the agent behind the firewall as described above.

Similarly, a software agent can also be used with operator proxy 160. The proxy 160 could be given the authority to penetrate firewall 158 to contact a software agent operating on operator computer 14. The agent would start the operator's browser automatically when a call comes in for a particular operator 16 whose agent is registered with proxy 160.

The embodiments described above are merely illustrative and skilled persons can make variations on them without departing from the scope of the invention, which is defined by the following claims.

1. A method for an operator to remotely control pages presented by a world wide web browser operating on a client computer, comprising:
contacting an operator server using the world wide web browser, the browser displaying on the client computer a primary browser window;
loading a first page into the primary browser window from the operator server, the first page including instructions to automatically open a child window in the browser and to download a second page into the child window;
opening the child window;
downloading the second page to the child window;
refreshing the child window by downloading a third page, the third page including, when the operator indicates that the information in the primary browser window is to be changed, an instruction to the primary browser window to load a new page; and
loading the new page into the primary browser window when the third page so instructs, thereby redrawing the primary window only when the operator indicates that the information in the primary window needs to be changed.

2. The method of claim 1 in which the operator server maintains a session status indicating the state of the connection between the client computer and the server and in which the child window indicates the session status.

3. The method of claim 1 in which refreshing the child window includes downloading an address from a memory location associated by the operator server with the client computer.

4. The method of claim 1 in which the instruction to the open the child window is in the form of a JavaScript command.

5. The method of claim 1 in which the operator server runs on an operator computer.

6. The method of claim 1 in which the operator server runs on a call center computer that supports multiple operators in communication with multiple client computers.

7. The method of claim 1 in which the operator server operates behind a firewall and in which contacting an operator server includes contacting outside of the firewall a proxy server representing the operator server.

8. The method of claim 1 in which the steps of refreshing the child window and loading a new page are repeated.

9. The method of claim 1 in which loading a new page includes logging which page was sent to the client computer.

10. A method of coordinating voice telephony communications and data communications over a computer network between an operator working in a call center with multiple operators and a customer operating a computer using network interface software, the method comprising:
sending a form over the computer network to the customer from a call center server, the form including fields for entering a customer name and a customer telephone number;
upon the call center server receiving the completed form posted by the customer, automatically initiating a telephone call to the customer;
connecting the telephone call to the customer to any available operator in the call center or to an operator specified by the customer;
upon connecting the customer to an operator, establishing a network session between the customer and the operator, whereby the operator causes the customer's network interface program to automatically display pages specified by the operator, without requiring the customer to enter addresses for each of the specified pages.

11. The method of claim 10 in which automatically initiating a call includes coordinating with a telephone server.

12. The method of claim 10 in which the customer's network interface program includes a browser and in which causing the customer's network interface program to display pages specified by the operator includes opening a child window of the customer's browser, the child window refreshing periodically and the refreshed window causing the browser to load a new page in a primary browser window if specified by the operator.

13. The method of claim 10 in which establishing an network session includes assigning a session identifier and designating a storage location associated with the session identifier.

14. The method of claim 10 in which connecting the telephone call to the client to any available operator in the call center or to an operator specified by the customer includes displaying a list of waiting customers to available operators and having available operators select waiting customers.

15. The method of claim 10 in which the call center server maintains a record of the pages sent to the customer computers.

16. A method of causing a network interface program on a client computer to display in a primary window information designated by a remote operator using an operator computer communicating with the client computer over a computer network, the network interface program operating on the client computer as an independent program process, comprising:
transmitting a page from the operator computer to the client computer, the page including instructions to automatically open a process or thread within the network interface independent program process;
opening the process or thread within the independent program process, the process or thread including an automatically self-refreshing window;
refreshing the self-refreshing window with a second page, the second page including instructions for loading a third page designated by the remote operator into the primary window;
automatically loading the third page into the primary window of the network interface program, whereby the remote operator causes the network interface program to automatically display pages specified by the remote operator, without requiring entry at the client computer of the addresses for each of the specified pages and the primary window is redrawn only when the remote operator indicates that its content is to be changed.

17. The method of claim 16 in which the network interface program comprises a web browser.

18. The method of claim 16 further comprising monitoring at the client computer for communications from the remote operator and automatically opening the network interface program in response to an communication from the remote operator indicating that the remote operator has information to display to the client.

19. The method of claim 16 further in which refreshing the self-refreshing window with a second page includes refreshing the self refreshing window with an instruction to load a page into the primary window, the page being identified from information in a memory location associated with the operator computer and designated to identify pages for loading onto the client computer.

20. A method of remotely causing the display on a client computer of information stored locally at the client computer on a storage device of unknown designation, the method comprising:
providing information to the client computer, the information including key information having an identifying characteristic;
searching for and locating on the key information, thereby determining the designation of the local storage device on which the information is stored; and
remotely causing the information to be displayed on the client computer, thereby allowing the information to be remotely displayed without having previous knowledge of the designation of the local storage device storing the information on the client computer.

21. The method of claim 20 in which the key information is in the form of a file name.

22. The method of claim 20 in which the local data storage device includes a compact disc reader and in which the designation of the local storage device includes a letter drive designation.

23. The method of claim 20 in which remotely causing the information to be displayed includes causing the information to be displayed in a primary window of a network interface program.

24. The method of claim 23 in which causing the information to be displayed in a primary window of a network interface program includes executing an instruction from a sub-process that causes the information to be displayed in the primary window.

25. The method of claim 24 in which sub-process includes a child window operating within the network interface program process.

26. A method of reducing the time required to provide specific information to a client using a client computer, the information being designated by a remote operator in communication with the client computer over a computer network, comprising:
providing the client with information to be stored locally at the client computer;
operating a network interface program on the client computer, the network interface program controlling the display of information in a primary window; and
remotely controlling the client computer through the network interface program and causing the client computer to display portions of the information designated by a remote operator.

27. The method of claim 26 in which providing the client with information to be stored locally at the client computer includes providing the client with multimedia information.

28. The method of claim 26 in which providing the client with information to be stored locally at the client computer includes providing the client with information on a compact disc.

29. The method of claim 26 in which the information provided includes a key file for remotely locating the information on the client computer and in which remotely controlling the client computer includes locating the key file to determine the location of the information at the client computer.
